(19) United States
(12) Patent Application Publication
(10) Pub. No.: US 2009/0244229 A1
(43) Pub. Date: Oct. 1, 2009

(54) Color-filter manufacturing method and color-filter manufacturing apparatus

(75) Inventor: Yasuhiko Maeda, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/382,804

(22) Filed: Mar. 24, 2009

(30) Foreign Application Priority Data
Mar. 25, 2008 (JP) 2008-079317

(51) Int. Cl. B41J 2/01

(52) U.S. Cl. 347/102

(57) ABSTRACT

A color-filter manufacturing method includes a first step in which an ink jet method is used to eject liquid inks which contain color components to form a land pattern made up of lands of light transmitting materials and a second step in which after drying of the thus ejected liquid inks, the ink jet method is used to eject a liquid ink which contains a light blocking material and the ink is allowed to permeate into a clearance between the lands, thereby forming a black matrix pattern.

The present invention claims priority from Japanese Patent Application No. 2008-079317 filed on Mar. 25, 2008, the entire content of which is incorporated herein by reference.

### BACKGROUND OF INVENTION

1. Field of the Invention

The present invention relates to a color-filter manufacturing method for manufacturing color filters on a face to be formed on a substrate surface or on that on a composition surface of the substrate. The color filters have a land pattern in which a plurality of kinds of light transmitting materials which transmit specific color components are arranged numerously in a land shape and a black matrix pattern in which a light blocking material is used to fill a periphery of each land and also relates to a color-filter manufacturing apparatus.

2. Description of the Related Art

For example, in a display device such as a liquid crystal display panel, color filters (such as red (R), green (G) and blue (B) color filters) are arranged to display colors for the respective pixels constituting an image to be displayed. Therefore, in order to display a highly fine color image, it is necessary to further miniaturize color filters and arrange them in association with a reduction in pixel size. Further, in order to improve display qualities such as contrast, a black matrix (BM) is arranged as a light-blocking region between the respective R, G, and B color filters.

In general, the above-described color filters are manufactured by a photo lithography process in which three color regions respectively made up of R, G, B and one color region made up of BM are sequentially formed on a substrate such as glass. However, the photolithography process requires an independent mask for each of the colors and also requires an exposure step and a development step, thus resulting in increased manufacturing cost, which is a problem.

Therefore, there has been proposed a method, in which, for example, only the BM is formed by photolithography, while three colors of R, G, and B are rendered and deposited at a bank part surrounded by walls of the BM. There has also been proposed manufacture of color filters according to an inkjet printing technology used in a printer for the purpose of a further reduction in cost, for example, in JP-A-09-211219 and JP-A-08-062417.

In JP-A-09-211219, an ink jet method is used to form all R, G, B and BM by one-time rendering or the BM is rendered and then R, G, and B are formed inside the bank thereof, thereby manufacturing color filters.

In JP-A-08-062417, the ink jet method is used to form all R, G, B and BM by one-time rendering and also in order to prevent color mixture of BM with R, G, and B, an ink material is used in which the polarity is reversed between color inks (R, G, B) and a black ink (BM).

However, as proposed in JP-A-09-211219 and JP-A-08-062417, where all R, G, B and BM are formed by one-time rendering, the rendering is determined for a maximum resolution, depending on the diameter of ink droplets ejected by an ink jet method or the landed droplet size (the diameter of droplets after landing on a substrate). Therefore, for example, where a region of the BM is desired to be very narrow, it is impossible to miniaturize and render the region thereof to a smaller extent than the diameter of droplets of ink particles or the landed droplet size, thus making it difficult to form finer color filters.

For example, as disclosed in JP-A-09-211219, even in a case where after the BM is rendered and dried, R, G, and B are rendered inside the bank thereof, as shown in FIG. 8, it is impossible to make a width W of the BM region smaller than the diameter of ink droplets of BM or the landed droplet size. Further, where after the bank of BM is formed and then R, G, and B are rendered, repellency is given to an upper part of the bank of BM, thereby preventing the deposition of R, G, and B inks and affinity is given to a side of the bank of BM, thereby attaining firm attachment of R, G, and B inks. Without the above-described adjustment, a white defect would develop on a border line between the BM and R, G, B, thereby resulting in a failure of manufacturing high-quality color filters. Thus, adjustment of the surface tension of ink is complicated and difficult.

In this instance, if adjustment is made for the surface nature of a substrate such as glass and ink droplets landing on the face thereof, for example, as shown in FIG. 9A, ink droplets are allowed to land in a liquid repellency state (contact angle >90 degrees). However, even in this instance, as shown in FIG. 9B, a maximum droplet size (W1) of landed droplets before drying is greater than a droplet size (W2) of a part which is in contact with the substrate. Therefore, in order to render, for example, a region of BM linearly, it is necessary to separate droplets so that adjacent droplets will not collide with each other during the rendering and will prevent bulging. For that purpose, rendering and drying are to be repeated. As a result, the manufacturing process is always made redundant.

Further, with the weight of ink droplets and an area in contact with a substrate taken into account, as shown in FIG. 10, droplets in a liquid repellency state are more likely to move due to the fluctuation of ambient air on drying or physical impact. Thus, this process will be low in reliability with respect to positional accuracy of patterning. In other words, volume V1 of ink droplets in a liquid repellency state is equal to volume V2 of droplets which are wet and spread. However, the latter is much greater in area in contact with the substrate and higher in positional retention and stability, while the ink droplets in a liquid repellency state are lower in positional retention and stability.

### SUMMARY OF INVENTION

The present invention has been made in view of the above situation, an object of which is to provide a manufacturing method for manufacturing color filters which are highly fine and available at low cost as well as an apparatus for manufacturing these color filters.

The above object of the present invention may be achieved by the following constitutions.
(1) According an aspect of the invention, a method for manufacturing a color filter that includes a substrate, and a land patter and a block matrix pattern on an uppermost surface of the substrate, wherein a land pattern includes a plurality of lands arranged, the plurality of lands containing light transmitting materials which transmit different color components, and a black matrix pattern includes a light blocking material and fills a clearance between adjacent lands of the light transmitting materials, the method includes forming the land pattern on the uppermost surface of the substrate by ejecting a first liquid ink containing at least one of the color components by an ink jet method, and forming the black matrix pattern on the uppermost surface of the substrate by ejecting, after drying of the first liquid ink, a second liquid ink containing the light blocking material by the ink jet method to permeate the clearance between adjacent lands of the dried first liquid ink with the ejected second liquid ink.

According to the color-filter manufacturing method, a width of the black matrix (BM) may be made smaller than a diameter of ink droplets containing the light blocking material. Specifically, after landing, the ink containing the light blocking material will penetrate, by permeation, into a narrow clearance between mutually adjacent lands of the light transmitting materials, thereby filling the clearance. Therefore, it is possible to form a linear BM pattern without repeating several times the rendering and drying of BM ink.
(2) The second liquid ink may have a repellency for a surface of the land pattern after drying the first liquid ink and an affinity for the uppermost surface of the substrate.

According to the color-filter manufacturing method, where upon supply of ink droplets containing a light blocking material according to an ink jet method in the second step into a clearance between a plurality of lands formed in the first step, ink droplets containing the light blocking material land or splatter on a land, ink on the land will move by being drawn naturally to a clearance region between the lands due to the repellency, thereby escaping into the clearance region having an affinity. Therefore, the ink containing the light blocking material is less likely to remain on the land, thereby improving the form accuracy of color filters.
(3) The land pattern may be formed on the uppermost surface of the substrate so that a width of the clearance between the adjacent lands is smaller than a diameter of a droplet of the second liquid ink.

According to the color-filter manufacturing method, since the liquid ink which contains the light blocking material and which is ejected in the second step penetrates, by permeation, into a clearance between mutually adjacent lands, it is possible to form a fine light-blocking region smaller in diameter than ink droplets to be ejected.
(4) The land pattern may be a pattern in which the plurality of lands are arrayed in a tetragonal lattice, and a central part of a cross-shaped clearance of the tetragonal lattice is set to be a landing target position of the second liquid ink.

According to the color-filter manufacturing method, since ink droplets containing a light blocking material are ejected to a cross-shaped clearance formed between mutually adjacent four lands, with the central part thereof given as a landing target position, there is obtained a greater allowance to a deviated landing position of ink droplets. Specifically, the cross-shaped positional clearance is greater than other clearances, and where the central part of the cross-shaped clearance is given as a landing target position, if landing even at a deviated position in the lateral direction or the vertical direction, the ink droplets containing the light blocking material may land easily inside the clearance. As a result, although the landing accuracy is relatively low, it is possible to manufacture high-quality color filters.
(5) According to an aspect of the invention, a color-filter manufacturing a color filter that includes a substrate, and a land patter and a block matrix pattern on a uppermost surface of the substrate, wherein a land pattern includes a plurality of lands arranged, the plurality of lands containing light transmitting materials which transmit different color components, and a black matrix pattern includes a light blocking material and fills a clearance between adjacent lands of the light transmitting materials, the apparatus includes a table on which the substrate is loaded, a head unit which is arranged so as to be moveable relative to the substrate on the table and which mounts an inkjet head, and a controller which controls the head unit to eject a first liquid ink containing the color components and a second liquid ink containing the light blocking material from the inkjet head to the substrate on the table.

According to the color-filter manufacturing apparatus, the inkjet head is used to form a land pattern with specific color components of inks such as R, G, and B on the face to be formed. After drying of the land pattern, the ink containing the light blocking material is ejected, and the ink containing the light blocking material is allowed to permeate into a clearance between lands on the land pattern, thus forming a black matrix (BM) pattern. It is, thereby, possible to make a width of the BM narrower than a diameter of ink droplets and also manufacture highly fine color filters easily.

According to the color-filter manufacturing method and the color-filter manufacturing apparatus in the present invention, an ink jet method is used to eject liquid inks of specific color components to form a land pattern. After drying of the land pattern, the ink jet method is used to eject a liquid ink which contains a light blocking material, thereby forming a black matrix pattern. Thus, even where a clearance between adjacent lands is made narrow, the ink containing the light blocking material permeates into a clearance between the lands and fills the clearance, thus making it possible to form a fine black matrix pattern by a simple process. As a result, it is possible to manufacture highly fine color filters at low cost.

Other aspects and advantages of the invention will be apparent from the following description and the appended claims.

### BRIEF DESCRIPTION OF THE DRAWINGS

FIG. 1 is a perspective view showing one constitution example of a color-filter manufacturing apparatus for manufacturing color filters;

FIG. 2 is a block diagram showing the apparatus given in FIG. 1;

FIG. 3 is a partially enlarged plan view of a color filter;

FIG. 4A is a drawing for explaining one example of procedures for forming a land pattern in a first rendering;

FIG. 4B is a drawing for explaining one example of procedures for forming a land pattern in a second rendering;

FIG. 4C is a drawing for explaining one example of procedures for forming a land pattern in a third rendering;

FIG. 5A is a plan view of a transparent substrate before landing of ink droplets;

FIG. 5B is a cross sectional view in the thickness direction of a transparent substrate before landing of ink droplets;

FIG. 6A is a plan view of the transparent substrate after landing of ink droplets;

FIG. 6B is a cross sectional view in the thickness direction of the transparent substrate after landing of ink droplets;

FIG. 7 is a drawing for explaining a landing target position of Bk-color ink droplets;

FIG. 8 is a cross sectional view showing a related cross-sectional structure in the thickness direction where R, G, B land patterns are formed after forming a black matrix pattern as in the related art;

FIG. 9A is a cross sectional view for explaining a related relationship between the diameter of ink droplets landed on a substrate and the diameter thereof after drying as well as the problem thereof;

FIG. 9B is a plan view for explaining a related relationship between the diameter of ink droplets landed on a substrate and the diameter thereof after drying as well as the problem thereof; and

FIG. 10 is a cross sectional view for explaining a landing state of droplets with an equal volume in the respective states that the inks and substrate are different in repellency and affinity.

### DESCRIPTION OF EXEMPLARY EMBODIMENTS

A detailed description will be given of preferred embodiments of the color-filter manufacturing method and the color-filter manufacturing apparatus in the present invention with reference to the drawings.

First, a description will be given of a constitution of a color-filter manufacturing apparatus.

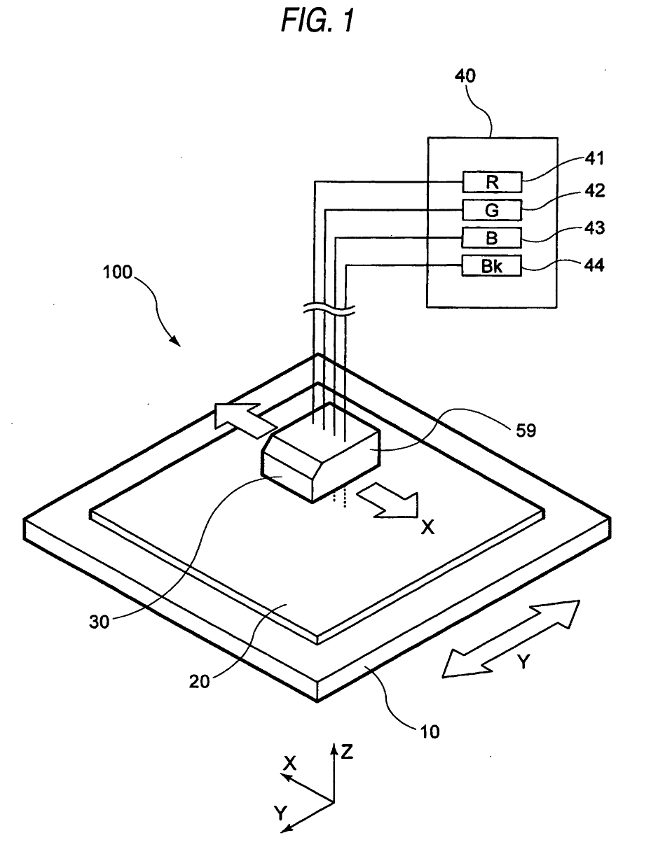

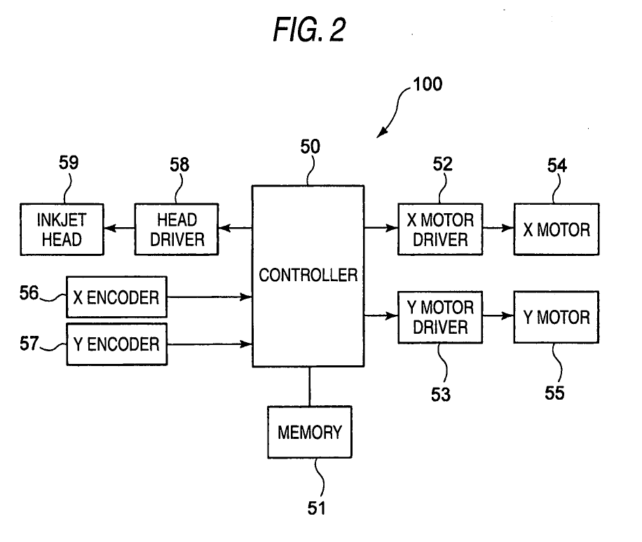

FIG. 1 is a perspective view showing one constitution example of the color-filter manufacturing apparatus for manufacturing color filters. FIG. 2 is a block diagram showing a constitution of the apparatus given in FIG. 1.

The color-filter manufacturing apparatus 100 is provided with a planar movable table 10 which may move along the Y axis direction. On the movable table 10, a transparent substrate 20 which is a substrate material of the color filter is placed. The transparent substrate 20 includes a transparent substrate such as glass or a film such as resin. Further, a head unit 30 which may move along the X axis direction orthogonal to the movement direction of the movable table 10 is arranged above the movable table 10. An inkjet head 59 is mounted on the head unit 30. The inkjet head 59 is connected via an ink supply tube to an ink cartridge 40.

The ink cartridge 40 is provided with a red (R) color liquid ink-filled R-color ink retaining portion 41, a green (G) color liquid ink-filled G-color ink retaining portion 42, a blue (B) color liquid ink-filled B-color ink retaining portion 43, and a light blocking material containing black (Bk) color liquid ink-filled Bk-color ink retaining portion 44, which constitute color filters.

The inkjet head 59 is provided with four kinds of nozzles which are mutually independent and able to eject liquid inks of red, green, blue and black colors as fine ink droplets.

Since the movable table 10 moves in the Y axis direction and the head unit 30 moves in the X axis direction, each of the nozzles is able to make a relative movement in the X and Y directions with respect to the face position of a transparent substrate 20. Therefore, the inkjet head 59 may be used to form (render) any given pattern with the respective inks of red, green, blue and black colors on the surface of the transparent substrate 20. It is noted that a supporting structure of the movable table 10 or a supporting structure of the head unit 30 is not limited to that illustrated in the drawing but other structures may be used. For example, such a structure may be acceptable that the head unit 30 moves within the XY plane, with the substrate 20 fixed, or the substrate 20 moves within the XY plane, with the head unit 30 fixed.

The color-filter manufacturing apparatus 100 shown in FIG. 1 is provided, as the block diagram thereof is shown in FIG. 2, with a controller 50 for attaining a comprehensive control, a memory 51, an X axis motor driver 52, a Y axis motor driver 53, an X axis driving motor 54, a Y axis driving motor 55, an X axis position encoder 56, a Y axis position encoder 57 and a head driver 58.

The controller 50 is constituted with a microcomputer, thereby controlling the apparatus comprehensively in accordance with the contents of previously set programs and data.

The memory 51 is a storage device retaining programs executed by the microcomputer of the controller 50 and information on rendering contents (positions, colors, rendering patterns).

The controller 50 drives the X axis driving motor 54 via the X axis motor driver 52, thereby driving the head unit 30. Further, the Y axis driving motor 55 allows the movable table 10 to move via the Y axis motor driver 53.

The X encoder 56 and the Y encoder 57 detect the moved distances of the head unit 30 and the movable table 10, outputting the respective position information to the controller 50.

The head driver 58 is a driver for driving an actuator (such as a piezoelectric element) for ejecting ink droplets from each nozzle of the inkjet head 59.

Therefore, the controller 50 allows the movable table 10 and the head unit 30 to move according to the programs and data retained in the memory 51, allowing the head unit to eject desired inks, thereby controlling these components so that a previously determined pattern is rendered on the transparent substrate 20.

Next, a description will be given of procedures in which the above-constituted color-filter manufacturing apparatus 100 is used to render inks on the transparent substrate 20 and manufacture color filters.

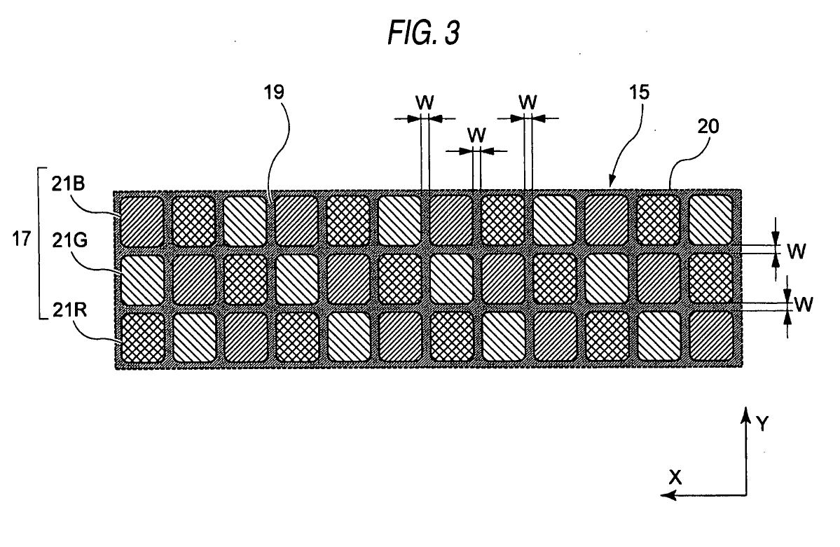

FIG. 3 shows a partially enlarged plan view of a color filter.

The color filter 15 illustrated here is a color filter having, on an uppermost surface of a substrate (on a face to be formed on a substrate surface or any composition surface formed on the substrate), a land pattern 17 in which a plurality of kinds of light transmitting materials which transmit specific color components (R, G, B, etc.) are arranged numerously in a land shape and a black matrix (BM) pattern 19 in which a light blocking material is used to fill a clearance between adjacent lands of the light transmitting materials.

In a first step of manufacturing the color filter, an ink jet method is used to eject liquid inks which contain specific color components, thereby forming a land pattern 17 containing light transmitting materials on the transparent substrate 20 to give a B-color land 21B, a R-color land 21R and a G-color land 21G as discrete patterns.

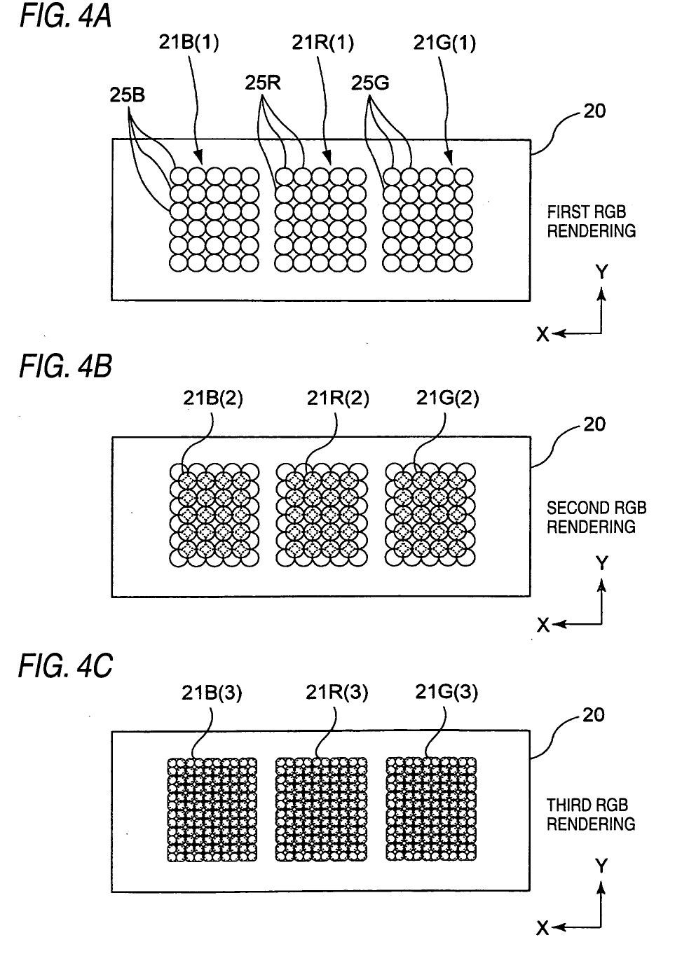

Specifically, the inkjet head 59 is used to render the B-color land 21B with a B-color ink, render the R-color land 21R with an R-color ink and render the G-color land 21G with a G-color ink. Further, each land is rendered at a predetermined interval W between these adjacent lands, thereby forming rectangular clearance regions 22a, 22b. Due to the presence of these clearance regions 22a, 22b, these color inks of the pattern 17 will not cause a color mixture with each other when they are rendered at the same time.

Where a size of each of the lands 21B, 21R, 21G is greater than a diameter of ink droplets, many ink droplets are used to form the land pattern 17. In order to eliminate a clearance inside the lands of the pattern 17, rendering is performed separately in a plurality of number of times as shown in FIGS. 4A to 4C.

FIGS. 4A to FIG. 4C illustrates an example in which in a first rendering, as shown in FIG. 4A, ink droplets of the respective colors are allowed to land so that such an interval that is in contact with an adjacent landing region is given to the landing regions 25B, 25G, 25R, thereby forming patterns of lands 21B(1), 21G(1), 21R(1).

Further, in a second rendering, as shown in FIG. 4B, ink droplets of the respective colors are used to perform rendering at positions which fill clearances of patterns of the lands 21B(1), 21G(1), 21R(1), thereby forming patterns of the lands 21B(2), 21R(2), 21G(2). Still further in a third rendering, as shown in FIG. 4C, ink droplets which are made smaller in size are used to form the patterns of the lands 21B(3), 21R(3), 21G(3) so as to fill clearances manufactured in the first and the second rendering patterns.

For example, where these lands 21B, 21R, 21G are in the size of one hundred to several hundred [μm], for example, an inkjet head with ejection capacity of 1 to 2 [pL] may be used to form a land having a desired shape or size by rendering several ink droplets on the condition that the resolution is based on the landed droplet size (φ) of 10 to 30 [μm]. It is noted that the ink droplets used in rendering may be a mixture of several types of them different from each other in diameter.

In an actual display device, it is necessary that lands of the respective R, G, and B color components are formed for each of the pixels constituting an image to be displayed, thereby controlling the light emission respectively. Thus, lands of each color are regularly formed on a color filter in a great number according to the number of pixels and panel size of the display panel, and a black matrix is formed at a periphery of each of the lands.

In the color filter of the present invention, details of which will be described later, an interval W between the clearance regions 22a, 22b may be made smaller than a diameter of light blocking material containing ink droplets which are ejected from the inkjet head 59.

After rendering of the above-described land pattern 17, an ink of each of these lands is dried. After drying of the ink of each of the lands, the BM pattern 19 is formed.

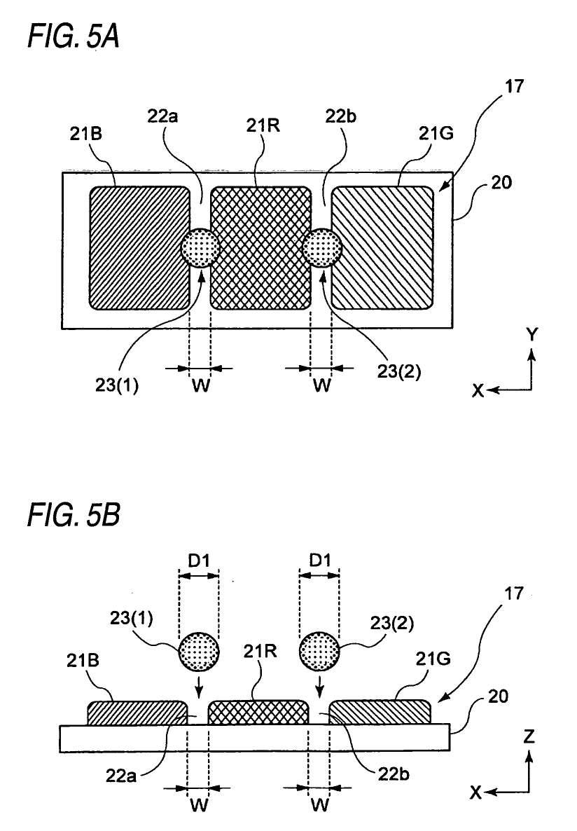

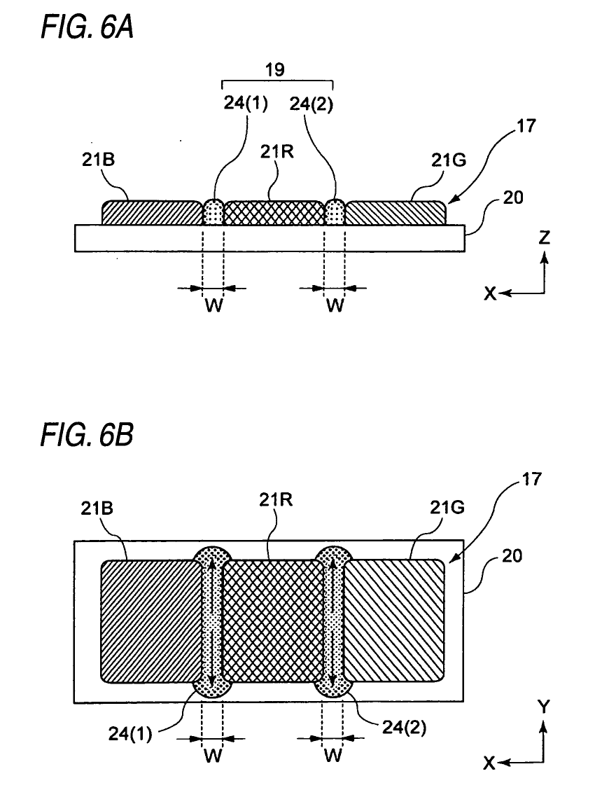

FIG. 5A is a plan view of a transparent substrate before landing of the ink droplets and FIG. 5B is a cross sectional view in the thickness direction of a transparent substrate before landing of the ink droplets. FIG. 6A is a plan view of the transparent substrate after landing of the ink droplets and FIG. 6B is a cross sectional view in the thickness direction of the transparent substrate after landing of the ink droplets.

As shown in FIGS. 5A and 5B, with a central part of a minimum width W of the clearance regions 22a, 22b given as a target position, Bk-color ink droplets 23(1), 23(2) containing a light blocking material are ejected from the inkjet head 59. Then, BM light-blocking regions 24(1), 24(2) shown in FIG. 6A and 6B are formed on the transparent substrate 20. In this instance, the diameter D1 of the ink droplets 23(1), 23(2) may be made greater than the width W of each of the clearance regions 22a, 22b. Further, the Bk-color ink used in forming the BM light-blocking regions 24(1), 24(2) is such an ink that, in addition to the light-blocking property, not only does it have repellency to the land surfaces of the B-color land 21B, R-color land 21R and G-color land 21G in a dry state but it also has an affinity for the surface of the transparent substrate 20 or a face to be formed.

An ink having the above-described properties is used as ink droplets 23(1), 23(2). Therefore, the ink droplets 23(1), 23(2) which have landed in each of the clearance regions 22a, 22b land on the transparent substrate 20. Thereafter, as shown in FIG. 6B, these ink droplets permeate through the clearance regions 22a, 22b along the surface of a substrate from the landing position, wetly spread without merging with the lands 21R, 21G, 21B. Thereby, the ink droplets flow so as to fill a space made up with each of the clearance regions 22a, 22b and side walls of the lands 21R, 21G, 21B and, as shown in FIG. 6B, the droplets are formed into a narrow linear pattern, that is, BM light-blocking regions 24(1), 24(2).

Even where the ink droplets 23(1), 23(2) land or splatter partially on any of the lands 21B, 21R, 21G, the ink droplets will flow into each of the clearance regions 22a, 22b but will not remain on the land due to the ink repellency.

The ink of each of the thus formed BM light-blocking regions 24(1), 24(2) is dried, thereby providing the color filter 15 high in form accuracy.

Here, a description is given of an example where the landing target position of the Bk-color ink droplets is a central position of the minimum width W in the clearance regions 22a, 22b between the lands 21B, 21R, 21G. However, the landing target position shall not be limited thereto. Where the land pattern 17 is a pattern in which each of the lands is arrayed in a tetragonal lattice shape, of clearances between the lands, the central part of a cross-shaped clearance is preferably set to be a landing target position of ink droplets.

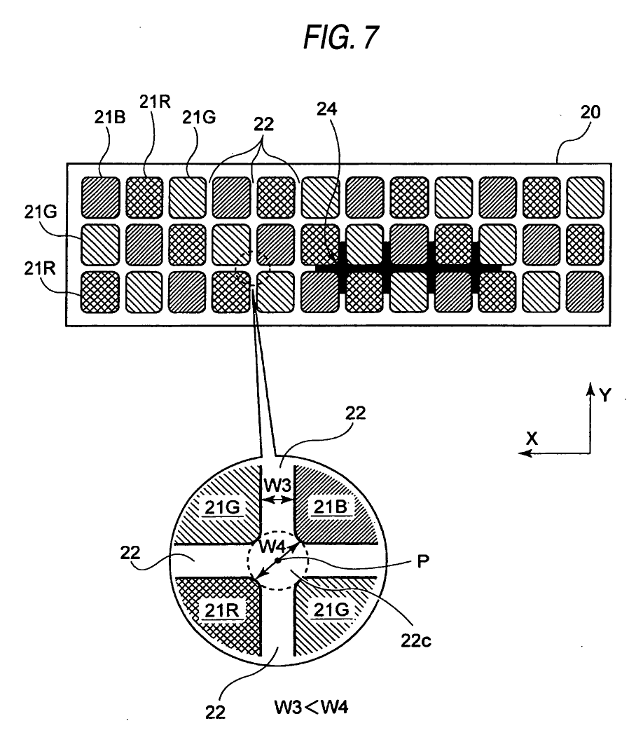

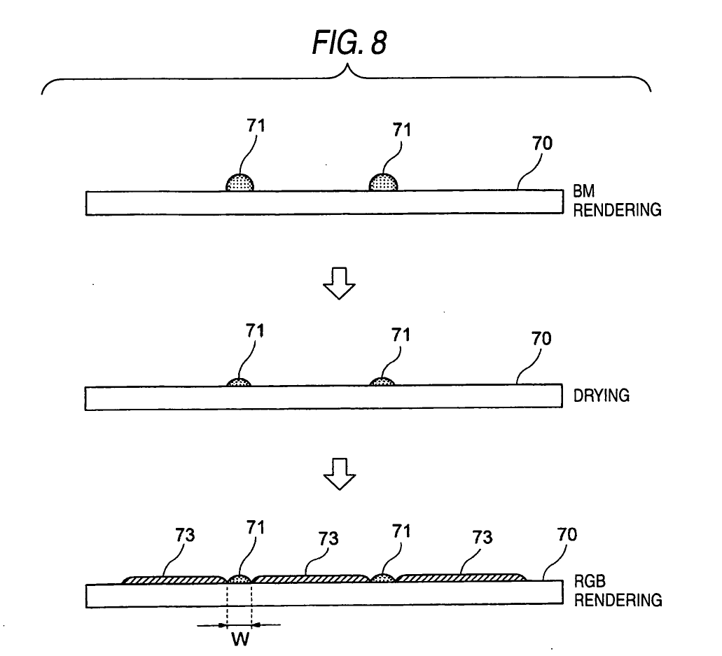

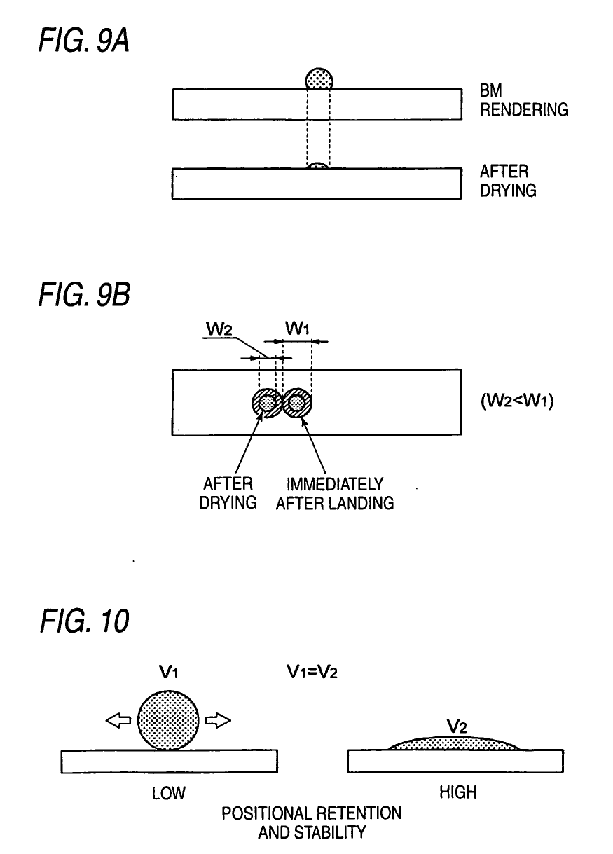

Specifically, as shown in FIG. 7, a clearance region 22 between the mutually adjacent two lands (between 21G and 21B, between 21R and 21G, or between 21B and 21R) includes a region extending to the X direction and that extending to the Y direction. The central position P of the cross-shaped clearance at which these regions intersect each other is set to be a landing target position of the Bk-color ink droplets.

At the cross-shaped site, or a clearance between four regions (any of the B-color land 21B, the R-color land 21R and the G-color land 21G) formed at mutually adjacent positions, as shown in FIG. 7, a dimension W4, which is the diameter of an inscribed circle of the clearance, is greater than a width W3 of the clearance 22. Therefore, with the central part 22c of the cross-shaped clearance, or the central position P, given as a target position, Bk-color ink droplets are allowed to land, thereby giving a greater allowance to a positional deviation. Further, even where the positional deviation takes place and the Bk-color ink droplets land at a position slightly deviated from the central position P of the cross-shaped clearance in the X direction or at a position slightly deviated therefrom in the Y direction, only if a position at which the ink droplets are actually allowed to land is within the central part 22c of the cross-shaped clearance, or within a clearance region connected to the central part 22c, the ink flows inside the clearance and is substantially free from influences resulting from the positional deviation.

Therefore, it is possible to lower a required specification of the landing accuracy for the Bk-color ink of the head unit 30. Even in the case of a constitution relatively low in accuracy, it is also possible to form the BM pattern 19 at a high accuracy. There is provided a constitution in which, for example, the Bk-color ink is isolated from the inkjet head 59 to install separate means for forming minute droplets such as a dispenser. In this instance, even where, for the purpose of giving light-blocking properties, inorganic particles mixed therein are increased in amount, inks may be ejected stably.

As described so far, according to the color filter manufactured according to the color-filter manufacturing method of the present invention, color lands 21B, 21R, 21G are rendered with the respective color inks and after drying of these inks, Bk-color ink droplets are allowed to land in a clearance region between each of the lands, the inks landed in the clearance region are allowed to permeate, thereby the width W of the clearance regions 22a, 22b may be set to be smaller than the diameter (D1) of ink droplets 23. Further, the thus landed Bk-color ink is an ink which is made with a material having repellency to the land surface, that is, the ink surface after drying of a light transmitting material, and also having an affinity for the surface of the transparent substrate 20 which is a face to be formed. Therefore, the ink permeates into the clearance region, or a region other than the land, and also ink droplets deposited on the land are repelled and flow into the clearance region, filling the land periphery completely.

It is, thereby, possible to form the BM light-blocking region 24 smaller in size than the ink droplets 23 into a fine linear shape by a simple process. Further, landed ink droplets 23 are spread into the clearance regions 22a, 22b and may be easily retained in the clearance region until the Bk-color ink is dried and less likely to be influenced by disturbance of ambient air or the like (fluctuation, impact, etc.). Thus, the Bk-color ink is improved in ink retaining stability, by which highly fine color filters may be stably manufactured to result in a reduction in manufacturing cost.

Further, on comparison with a case where, R, G, and B lands are formed after forming the BM, the degree of difficulty in designing the surface energy between each of the inks and the BM may be reduced drastically. Specifically, only adjustment is made for the surface energies between the BM ink and a substrate and between the BM ink and the respective R, G, B inks after drying. Thus, it is not necessary to control the surface energy in a complicated manner, for example, repellency is given to an upper part of a bank of the BM so that the R, G, and B inks will not deposit, while affinity is given to a side part of the bank of the BM so that R, G, and B inks may be firmly attached.

The color-filter manufacturing method and the color-filter manufacturing apparatus in the present invention are applicable to a case where a color filter is manufactured in which a plurality of colors of light transparency regions which transmit specific color components such as R, G, and B are regularly arranged numerously and formed on a substrate, and a light-blocking region (BM) which blocks light is formed at border positions of a plurality of light transparency regions. They are technologies particularly useful in attaining at the same time the miniaturization of light-blocking regions and a reduction in manufacturing cost.

1. A method for manufacturing a color filter that includes a substrate, and a land patter and a block matrix pattern on an uppermost surface of the substrate, wherein a land pattern includes a plurality of lands arranged, the plurality of lands containing light transmitting materials which transmit different color components, and a black matrix pattern includes a light blocking material and fills a clearance between adjacent lands of the light transmitting materials, the method comprising:
forming the land pattern on the uppermost surface of the substrate by ejecting a first liquid ink containing at least one of the color components by an ink jet method; and
forming the black matrix pattern on the uppermost surface of the substrate by ejecting, after drying of the first liquid ink, a second liquid ink containing the light blocking material by the ink jet method to permeate the clearance between adjacent lands of the dried first liquid ink with the ejected second liquid ink.

2. The method according to claim 1, wherein the second liquid ink has a repellency for a surface of the land pattern after drying the first liquid ink and an affinity for the uppermost surface of the substrate.

3. The method according to claim 1, wherein the land pattern is formed on the uppermost surface of the substrate so that a width of the clearance between the adjacent lands is smaller than a diameter of a droplet of the second liquid ink.

4. The method according to claim 1, wherein the land pattern is a pattern in which the plurality of lands are arrayed in a tetragonal lattice, and
a central part of a cross-shaped clearance of the tetragonal lattice is set to be a landing target position of the second liquid ink.

5. An apparatus for manufacturing a color filter that includes a substrate, and a land patter and a block matrix pattern on a uppermost surface of the substrate, wherein a land pattern includes a plurality of lands arranged, the plurality of lands containing light transmitting materials which transmit different color components, and a black matrix pattern includes a light blocking material and fills a clearance between adjacent lands of the light transmitting materials, the apparatus comprising:
a table on which the substrate is loaded;
a head unit which is arranged so as to be moveable relative to the substrate on the table and which mounts an inkjet head; and
a controller which controls the head unit to eject a first liquid ink containing the color components and a second liquid ink containing the light blocking material from the inkjet head to the substrate on the table in accordance with a method for manufacturing of the color filter comprising:
forming the land pattern on the uppermost surface of the substrate by ejecting a first liquid ink containing at least one of the color components by an ink jet method; and
forming the black matrix pattern on the uppermost surface of the substrate by ejecting after drying of the first liquid ink, a second liquid ink containing the light blocking material by the ink jet method to permeate the clearance between adjacent lands of the dried first liquid ink with the ejected second liquid ink.
